(19) United States
(12) Patent Application Publication
(10) Pub. No.: US 2026/0260140 A1
(43) Pub. Date: Sep. 3, 2026

(54) FUZZY LOGIC-BASED CLASSIFICATION MODEL

(71) Applicant: AUMOVIO Autonomous Mobility Germany GmbH, Ingolstadt (DE)

(72) Inventor: Matthias BRENDEL, Lindau (DE)

(73) Assignee: AUMOVIO Autonomous Mobility Germany GmbH, Ingolstadt (DE)

(21) Appl. No.: 19/163,066

(22) PCT Filed: Feb. 29, 2024
(86) PCT No.: PCT/DE2024/200010

§ 371 Date: Sep. 8, 2025

(30) Foreign Application Priority Data
Mar. 31, 2023 (DE) 10 2023 202 983.9

(51) Int. Cl. G06N 5/048

(52) U.S. Cl. CPC G06N 5/048

(57) ABSTRACT

A method, in particular a computer-implemented method, for classifying at least one object, a method for training a fuzzy logic model using at least one membership function for classifying at least one object, a computer program for performing the method, and a computer program product. The classification method including: providing input data I which contain at least one item of information about the at least one object; providing at least the input data as input for a trained fuzzy logic model using at least one membership function for at least one predefinable class for the fuzzy logic model, wherein the fuzzy logic model is configured to use the input as a basis for determining a probability of the at least one object belonging to the at least one predefined class; and outputting the classification result.

### CROSS REFERENCE TO RELATED APPLICATIONS

This application is the U.S. National Phase Application of PCT International Application No. PCT/DE 2024/200010, filed Feb. 29, 2024, which claims priority to German Patent Application No. 10 2023 202 983.9, filed Mar. 31, 2023, the contents of such applications being incorporated by reference herein.

### FIELD OF THE INVENTION

The invention relates to a method, in particular a computer-implemented method, for object classification by means of a trained fuzzy logic model, to a method, in particular a computer-implemented method, for training a fuzzy logic model, to a computer program for performing the method according to the invention, and to a computer program product on which the method is stored.

### BACKGROUND OF THE INVENTION

For object classification, in particular in the field of driver assistance systems, input data from sensors, for example from a radar sensor, ultrasonic sensor, lidar sensor or a camera, are examined for the presence of various predefinable features and, if necessary, these features are assigned to particular object classes. In this context, many different methods and in particular also numerous approaches from the field of machine learning have become known. Assignment to an object class is, for example, carried out with the aid of an activation function which can be used to define particular value ranges for the detected features.

In the context of methods from machine learning, the potential of taking into account background information about the respectively considered system and simple logic statements or the inclusion of symbolic approaches, such as, for example, of elements from the field of fuzzy logic, is also increasingly being discussed. Fuzzy logic models are often used in control systems and are mainly used to formalize background knowledge and to take uncertainties into account. However, the inclusion of fuzzy logic models in machine learning methods presents various problems based on differentiability and associated with the vanishing gradient problem, as has been described in “Analyzing Differentiable Fuzzy Logic Operators” by E. van Krieken et al., published in 2020 on arXiv, last revised on Aug. 24, 2021, arXiv:2002.06100 (DOI: https://doi.org/10.1016/j.artint.2021.103602), and incorporated by reference herein.

The use of a Logic Tensor Network (LTN) is proposed to overcome the hurdles associated with the vanishing gradient problem. In this case, the membership functions are determined with the aid of a neural network with sigmoid activation functions. Such a procedure provides continuously differentiable membership functions. However, this is disadvantageously associated with huge computing effort and less clear interpretability.

A way of classifying and tracking objects has additionally been known from U.S. Pat. No. 5,761,326A, incorporated by reference herein, in which camera images for each pixel are analyzed with regard to the intensities of horizontal and vertical edge elements, and vectors are calculated using the magnitude and the angle for each pixel. Then, the fuzzy set theory is applied to the vectors in a predefinable region in order to generate a single vector which characterizes the predefinable region. This vector is then interpreted by means of a neural network in order to perform object classification. The method is therefore time-consuming.

### SUMMARY OF THE INVENTION

A way of classifying objects which is suitable for embedded systems with limited computing capacity but is still capable of classifying a large number of objects would be desirable.

With respect to the method, an aspect of the invention is achieved by a method, in particular a computer-implemented method, for classifying at least one object, comprising the following method steps:
providing input data which contain at least one item of information about the at least one object,
providing at least the input data as input for a trained fuzzy logic model using at least one membership function for at least one predefinable class for the fuzzy logic model, wherein the fuzzy logic model is configured to use the input as a basis for determining a probability of the at least one object belonging to the at least one predefined class, and
outputting the classification result.

According to an aspect of the invention, membership functions for different classes and/or characteristic features within a class are thus determined and classification is carried out directly on the basis of a fuzzy logic model. For example, the membership functions can be defined at least in part based on a priori knowledge of the respectively selected classes and/or features. However, membership functions can also be determined at least in part in a machine learning method. For classification, an object can then be assigned, for example, to the predefined class for which the probability of belonging is highest.

Advantageously, a comparatively low computing capacity is required for the procedure according to an aspect of the invention. The method is thus very well suited for embedded systems and can still be carried out for classifying many different objects in each acquisition cycle for acquiring input data.

In the context of an aspect of the present invention, a fuzzy logic model is to be understood to be a model based on the fuzzy set theory and/or fuzzy logic. Fuzzy logic is based on fuzzy sets, the elements of which belong to the set to a certain degree. Assignment to a fuzzy set is carried out on the basis of one or more membership functions which are able to be combined to form fuzzy functions.

In one advantageous configuration, the membership function used is a piecewise linear or piecewise constant function, in particular a step function or a trapezium function. Such membership functions are advantageously associated with reduced computing effort compared to other function types. In addition, the classification results obtained with the aid of such functions are particularly easy and accurate to interpret and both linear and non-linear behavior can be considered. It is possible to distinguish between different non-linear object variables. In addition, little computing time is required for object classification.

It is also advantageous if the membership function is described based on predefinable function parameters, which function parameters are parameters of the fuzzy logic model. If a plurality of membership functions are used, they can also be combined with each other. For example, a sum, a maximum, a minimum or a product of different function parameters can then be used to determine a probability of the at least one object belonging to the predefined class on the basis of a plurality of membership functions.

According to one advantageous configuration of the method, at least two intervals are predefined for at least one function variable of the membership function, wherein for each interval a membership subfunction is determined, and wherein the membership function is composed of the membership subfunctions. For example, there can be one or more intervals in which the membership function assumes one or more constant values which, for example, relate to different probabilities. Preferably and particularly advantageously with regard to the computing effort, each membership subfunction is a linear or constant function.

In this respect, it is advantageous if each interval is characterized by at least one interval value, which interval value is in particular a start or end value of the interval.

According to a further configuration of the method, the input data are sensor data from a sensor, in particular a radar sensor or a camera. However, input data from other suitable sensors can also be used.

It is also advantageous if the at least one item of information about the object is a geometric variable relating to the object, in particular a geometric dimension, such as a length, width, or area of the object, a position, a speed, an acceleration, or a radar cross section.

An aspect of the invention is also achieved by a method, in particular a computer-implemented method, for training a fuzzy logic model using at least one membership function for classifying at least one object, comprising the following method steps:
providing training data which contain at least one item of information about the at least one object,
providing an indication with regard to a class for the at least one object for all training data,
generating an output of the fuzzy logic model for all training data by processing the training data by means of the fuzzy logic model in accordance with parameters for the fuzzy logic model,
comparing the generated output with the indication using at least one error function, and
optimizing the parameters on the basis of the comparison.

The fuzzy logic model is preferably used for the inventive method for classifying at least one object according to one of the previously described configurations. The output of the fuzzy logic model is preferably a probability of the at least one object belonging to the at least one class. In the case of a plurality of characteristic features, a combination of the individual probabilities, for example by forming a sum or a product, can also be determined as a classification result. In turn, the class for which the probability is highest is output for the assignment to one of a plurality of classes. This output, preferably determined by means of an argmax operator, is then the classification result.

The error function can be given, for example, due to a number of incorrect classifications, or a difference between the determined probabilities or the classification result and the indication. For example, the probability can be normalized to an interval with values between 0 and 1. Preferably, the error function is minimized during the training method. The training method can be started or carried out several times.

With respect to the method for training the fuzzy logic model, it is advantageous if the parameters for the fuzzy logic model are optimized on the basis of a gradient method or on the basis of a method of steepest descent. In this case, a random initialization can be advantageously selected.

It is also advantageous if regularization is carried out. In this context, a regularization term can be added to the error function. Regularization can ensure that the output of the fuzzy logic model, in particular the probability or the classification result, is greater than zero and as small as possible. For example, for such scenarios for which there is little training data, low values or probabilities are therefore output as standard. Furthermore, regularization can be used to ensure that start and end values of the intervals for the membership function lie within the value ranges of the input for the fuzzy logic model. For example, there is thus no need to define membership subfunctions which are not required.

In a further configuration for the training method, at least two intervals are predefined for at least one function variable of the membership function, wherein for each interval a membership subfunction is determined, and wherein the membership function is composed of the membership subfunctions.

A further configuration involves each interval being characterized by at least one interval value, wherein in the event that a value for an n-th interval value, in particular in a training cycle, is greater than a value for an n-1-th interval value, the values for the n-th and the n-t-th interval value are swapped before the parameters are evaluated. In contrast, the function values of the respective membership subfunctions are not swapped. In the event that the interval values are the start and/or end values of the interval, if a start value in a training cycle is greater than the end value, the start value and the end value are then swapped, for example. In this way, the error function is mirrored at the limits of the search space. Discontinuation of the training method due to invalid parameter values can thus be prevented.

The method according to an aspect of the invention for classifying at least one object is preferably used for object classification, in particular within a driver assistance system. The method according to an aspect of the invention is particularly preferably used for object classification by means of a radar sensor or a camera. It is also advantageous if the method is used for classifying object types, for example different categories of vehicles such as trucks or passenger cars.

An aspect of the present invention likewise relates to a driver assistance system which is configured to carry out the inventive method for classifying at least one object. In the case of a driver assistance system, the objects are, for example, other road users, in particular vehicles or pedestrians, road boundaries or other objects in the respective detection range of the sensors used.

An aspect of the invention is also achieved by a computer program having instructions which, when the computer program is executed by a computer, cause the computer to perform the inventive classification method according to one of the described configurations or the inventive method for training a fuzzy logic model.

An aspect of the invention is also achieved by a computer program product on which a computer program according to an aspect of the invention is stored.

Reference should be made to the fₐct that the advantages in connection with the inventive method for classifying at least one object are also applicable, mutatis mutandis, in connection with the training method according to an aspect of the invention, the computer program according to an aspect of the invention, and the computer program product according to an aspect of the invention, and vice versa.

### BRIEF DESCRIPTION OF THE DRAWINGS

Aspects of the invention and its advantageous configurations are explained in more detail with reference to the following figures. In the figures:

FIG. 1 shows an example of a sectionally constant membership function composed of a plurality of membership subfunctions;

FIG. 2 shows a further example of a membership function;

FIG. 3 shows a flowchart for one configuration of the inventive method for classifying objects; and

FIG. 4 shows a flowchart for one configuration of the training method according to an aspect of the invention.

In the figures, identical elements are provided with the same reference sign.

### DETAILED DESCRIPTION OF EXEMPLARY EMBODIMENTS

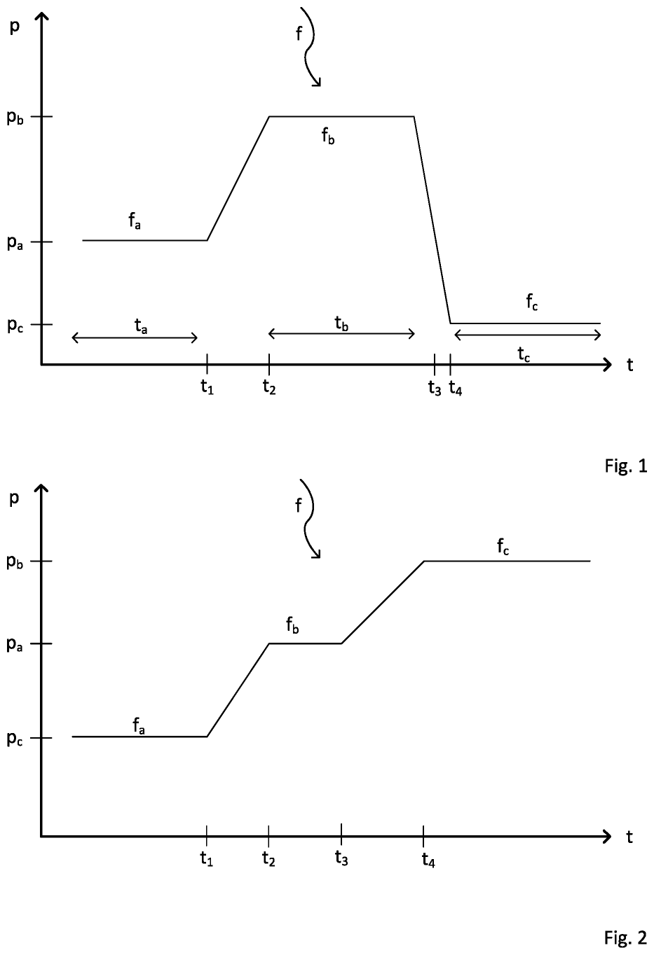

In FIG. 1, a membership function f is sketched in the form of a piecewise linear or constant function, here in the form of a trapezium function. The trapezium function f can be defined based on three membership subfunctions fₐ-f_{c} for the intervals tₐ-t_{c}, in each of which the membership function f is constant. Between the constant intervals tₐ-t_{c}, the membership function f has a linear profile. In other configurations, the intervals tₐ-t_{c} can also be adjacent and intervals can also be defined for ranges in which the membership function f is not constant.

The three intervals tₐ-t_{c} can in turn be characterized on the basis of four interval values t₁-t₄ for the function variable t, each of these interval values being start or end values of the intervals tₐ-t_{c}. For the example shown here: tₐ: [−ο; t₁], t_{b}: [t₂; t₃], and t_{c}: [t₄; ο]. For each interval tₐ-t_{c} a probability pₐ-p_{c} is also defined.

A different number of intervals and/or a different number of interval values can be useful for characterizing other membership functions f. In FIG. 2, a further example of a membership function f in the form of a step function with three constant ranges tₐ-t_{c} is depicted.

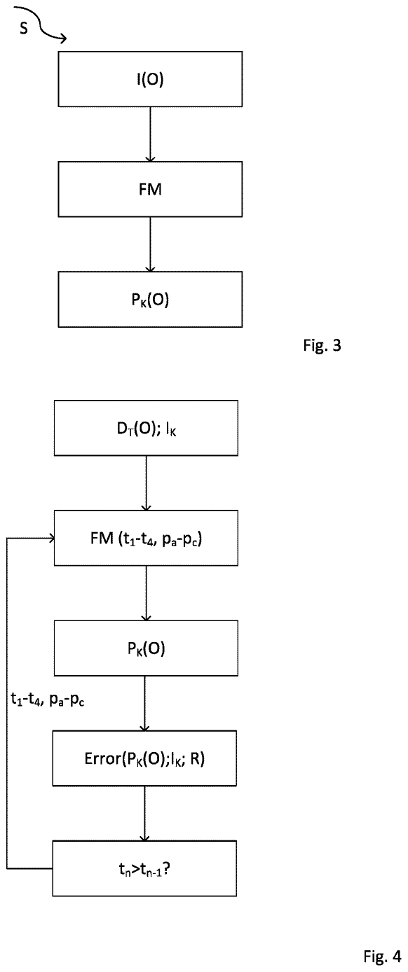

In FIG. 3, a flowchart for one advantageous configuration of the inventive method for classifying objects is illustrated. In a first method step, input data I(O) which contain at least one item of information about at least one object O to be classified are provided. The input data I(O) are preferably measured data from one or more sensors S, such as, for example, a radar sensor or a camera. The input data I(O) are used as input for a trained fuzzy logic model FM which determines a probability Pk(O) of belonging to at least one predefinable class K and outputs the respectively obtained classification result.

The fuzzy logic model FM is based on at least one membership function f for the at least one predefinable class K. The membership function f is preferably described based on predefinable function parameters, e.g. t₁-t₄, pₐ-p_{c}, which function parameters are also parameters of the fuzzy logic model FM.

In the case of a plurality of classes K, a probability P_{K}(O) is determined for each class K. In this case, that class for which the probability P_{K}(O) is highest can be output as the classification result, for example.

Finally, in FIG. 4, one advantageous configuration for the inventive training method for training a fuzzy logic model FM using at least one membership function f for classifying at least one object O is depicted. Starting from a set of training data TD(O) which have at least one item of information about at least one object O and an indication I_{K} with respect to the at least one object O, an output of the fuzzy logic model PK(O) is generated in accordance with parameters t₁-t₄, pₐ-p_{c} of the fuzzy logic model FM. This output PK(O) is in each case compared with the indication I_{K} using an error function Error and the parameters t₁-t₄, pₐ-p_{c} are optimized on the basis of the comparison.

Optimization of the parameters t₁-t₄, pₐ-p_{c} can be performed, for example, by means of a gradient method or on the basis of a method of steepest descent. In addition, regularization R can optionally be carried out. In addition, if a value for an n-th interval value tₙ in an optimization cycle is greater than a value for an n-1-th interval value tₙ₋₁, the values for the n-th and n-t-th interval values tₙ and tₙ₋₁ are swapped before the parameters t₁-t₄, pₐ-p_{c} are optimized. This does not affect the values for the probabilities pₐ-p_{c}. This means that if, for example, in a training cycle, the start value t₂ for the second interval t_{b} is greater than its end value t₃, the start value t₂ and the end value t₃ are swapped.

1. A computer-implemented method, for classifying at least one object, comprising:
providing input data which contain at least one item of information about the at least one object,
providing at least the input data as input for a trained fuzzy logic model using at least one membership function for at least one predefinable class for the fuzzy logic model, wherein the fuzzy logic model is configured to use the input as a basis for determining a probability of the at least one object belonging to the at least one predefined class, and
outputting the classification result.

2. The method as claimed in claim 1, wherein the membership function used is a piecewise linear or piecewise constant function, a step function or a trapezium function.

3. The method as claimed in claim 1, wherein the membership function is described based on predefinable function parameters, which function parameters are parameters of the fuzzy logic model.

4. The method as claimed in claim 1,
wherein at least two intervals are predefined for at least one function variable of the membership function, wherein for each interval a membership subfunction is determined, and wherein the membership function is composed of the membership subfunctions.

5. The method as claimed in claim 4, wherein each interval has at least one interval value, which interval value is start or end value of the interval.

6. The method as claimed in claim 1,
wherein the input data are sensor data from a sensor.

7. The method as claimed in claim 1, wherein the at least one item of information about the object is a geometric variable relating to the object, selected from the group consisting of a geometric dimension, a position, a speed, an acceleration, or a radar cross section.

8. A computer-implemented method, for training a fuzzy logic model using at least one membership function for classifying at least one object, comprising
providing training data which contain at least one item of information about the at least one object,
providing an indication with regard to a class for the at least one object for all training data,
generating an output of the fuzzy logic model for all training data by processing the training data by means of the fuzzy logic model in accordance with parameters for the fuzzy logic model,
comparing the generated output with the indication using at least one error function, and
optimizing the parameters on the basis of the comparison.

9. The method as claimed in claim 8,
wherein the parameters are optimized on the basis of a gradient method or on the basis of a method of steepest descent.

10. The method as claimed in claim 8, wherein regularization is carried out.

11. The method as claimed in claim 8,
wherein at least two intervals are predefined for at least one function variable of the membership function, wherein for each interval a membership subfunction is determined, and wherein the membership function is composed of the membership subfunctions.

12. The method as claimed in claim 11,
wherein each interval has at least one interval value, which interval value is a start or end value of the interval, and wherein in the event that a value for an n-th interval value is greater than a value for an n-1-th interval value, the values for the n-th and the n-t-th interval value are swapped before the parameters are optimized.

13. The use of the method as claimed in claim 1 for object classification, within a driver assistance system.

14. A computer program having instructions which, when the computer program is executed by a computer, cause the computer to perform the method as claimed in claim 1.

15. A non-transitory computer program product on which the computer program as claimed in claim 14 is stored.

16. A computer program having instructions which, when the computer program is executed by a computer, cause the computer to perform the method as claimed in claim 8.

17. The method as claimed in claim 6, wherein the sensor is a radar sensor or a camera.
